(19) United States
(12) Patent Application Publication
(10) Pub. No.: US 2017/0368782 A1
(43) Pub. Date: Dec. 28, 2017

(54) MULTILAYER SEALED SKIN FOR A PRESSURIZED FLEXIBLE STRUCTURE AND FLEXIBLE STRUCTURE USING SUCH A SKIN

(71) Applicant: AIRBUS GROUP SAS, Blagnac (FR)

(72) Inventors: Albert ABISROR, Boulogne Billancourt (FR); Didier MESNAGE, Saint Cloud (FR)

(21) Appl. No.: 15/527,976

(22) PCT Filed: Nov. 18, 2015
(86) PCT No.: PCT/EP2015/077007

§ 371 Date: May 18, 2017

(30) Foreign Application Priority Data
Nov. 20, 2014 (FR) 1461234

(51) Int. Cl. B32B 1/00; B32B 7/08; B32B 7/12; B32B 9/02; B32B 5/02; B32B 27/06; B32B 27/12; B32B 37/12; B32B 9/04; B32B 5/18; B32B 38/00; B64B 1/08; B64B 1/40; B64G 1/22; B64C 3/30

(52) U.S. Cl. CPC B32B 1/00; B32B 5/18; B32B 7/08; B32B 7/12; B32B 9/02; B32B 5/028; B32B 27/065; B32B 27/12; B32B 37/12; B32B 9/045; B32B 2038/008; B32B 2250/40; B32B 2266/02; B32B 2305/022; B32B 2305/18; B32B 2307/7166; B64B 1/08; B64B 1/40; B64G 1/22; B64C 3/30

(57) ABSTRACT

A multilayer sealed skin, in particular for an inflatable structure and that includes a first polymer film, a reinforcing fabric disposed on the first polymer film and a second polymer film disposed on the reinforcing fabric and adhered by means of an adhesive to the first polymer film through cavities in the reinforcing fabric. The skin can be applied to the production of an inflatable structural element such as an inflatable beam for which the skin forms an outer wall of the structural element and for which the first film of the skin forms an inner face of the outer wall of the structural element, and the second film forms an outer face of the wall.

### CROSS-REFERENCE TO RELATED APPLICATIONS

This application is the National Stage of International Application No. PCT/EP2015/077007, having an International Filing Date of 18 Nov. 2015, which designated the United States of America, and which International Application was published under PCT Article 21(2) as WO Publication No. 2016/079202 A1, and which claims priority from, and the benefit of, French Application No. 1461234, filed on 20 Nov. 2014, the disclosures of which are incorporated herein by reference in their entireties.

### BACKGROUND

### 1. Field

The presently disclosed embodiment relates to inflatable flexible structures designed to be pressurized, and it is intended in particular for producing beams, tubes bearing solar panels, air brake wing structures or antenna reflectors for satellites and possibly structural frame elements of airships, weather balloons or any other object in which lightness is a primary characteristic.

The presently disclosed embodiment relates in this context to a multilayer sealed skin for a pressurized flexible structure and to a flexible structure using such a skin.

### 2. Brief Description of Related Developments

The production of pressurized inflatable load-bearing tubes is known from U.S. Pat. No. 5,311,706 A and WO Publication No. 2007/096289 A1, for example, for deploying large inflatable structures.

The constraints on the structural members for the devices to be deployed consist in obtaining a sufficient rigidity under pressurization without the risk of tearing, while minimizing as far as possible the mass of these members and the volume taken up thereby when deflated.

In the prior art in relation to inflatable beams, several films ensuring the sealing of the beam are bonded to one another. In most cases, the films for ensuring sealing are bonded on the outside faces of the inflatable beam. Thus, when a high internal pressure is applied, these films may become detached, leading to sealing defects. This results in a loss of rigidity of the flexible beam over time, and even the collapse of the latter.

To date, there are several ways of ensuring the sealing of inflatable structures:

a) Internal spraying of a polymer solution onto the reinforcing fabric;

b) Bonding of a film on the outside face of a reinforcing fabric;

c) The production of flexible structures reinforced by compression/vulcanization (pneumatic) methods and derived methods.

The first solution does not provide a satisfactory result. To be specific, it is difficult to achieve homogenous spraying over the entire surface (presence of micro-holes and excess polymer in some places). This method does not therefore ensure good sealing and moreover, the structure produced is fairly heavy.

The second solution consists in bonding a film on a reinforcing fabric on the inside face of the beam. Bonding of two different materials is not very easy, making this method difficult to implement. Moreover, said bonding is carried out on the outside face of the beam and thus, when a relatively high pressure is applied, the film may become detached from the fabric.

One of the aims of the presently disclosed embodiment is therefore to minimize, and at best eliminate, the problems relating to the sealing of the inflatable structure due to the films becoming detached. This makes it possible to keep the rigidity of a flexible structure constant over time and thus to increase its service life. In addition, the presently disclosed embodiment comprises film/film bonding, which is easier than bonding between a film and a reinforcing fabric.

### SUMMARY

In this context, the presently disclosed embodiment relates to a structure, such as a beam with a section of any shape, with a multilayer sealed skin, composed of polymer films encasing a reinforcing fabric made of synthetic fibers, in particular technical fibers such as carbon fibers, aramid fibers, polymer fibers or the like, while making it possible to render the structure load-bearing by creating a pre-stressed state after internal pressurization. This type of beam may be integrated, for example, into the framework of deployable elements of satellites in order to make the structure more lightweight.

The presently disclosed embodiment thus proposes, first, a multilayer sealed skin, in particular for an inflatable structure, which comprises a first polymer film, a reinforcing fabric arranged on the first polymer film, and a second polymer film arranged on the reinforcing fabric and bonded by means of an adhesive to the first polymer film through holes in the reinforcing fabric.

The reinforcing fabric preferably comprises meshes, the spacing of which is adapted as a function of the thickness of the reinforcing fabric, the flexibility of said polymer films and the fluidity of the adhesive to allow bonding between the first and second films.

The reinforcing fabric is advantageously a synthetic fiber fabric.

The disclosed embodiment also proposes an inflatable structural member such as an inflatable beam comprising a sealed skin according to the disclosed embodiment forming an outer wall of the structural member, for which the first film of the skin forms an inside face of the outer wall of the structural member and the second film forms an outside face of said wall.

The member has two sealed skins, and the latter are connected to one another by armor wires which give the structural member rigidity.

The armor wires advantageously connect the first films of the two skins by means of a stitching operation, the reinforcing fabrics of the skins covering the loops of the wires on the outside face of the first films.

The second films of the skins are advantageously bonded to the first films through the holes between the meshes of the reinforcing fabrics, the loops of the stitching being embedded in the adhesive between the first and second films.

The disclosed embodiment also proposes a method for producing an inflatable structural member according to the disclosed embodiment which comprises a step of depositing first films on either side of a removable solid core between the two films.

The method advantageously comprises a step of stitching an armor wire through the assembly formed by the two first films and the solid core. The stitching step optionally comprises a step of adding a retaining wire to hold the loops in place on one side of the stitching. The function of the armor wire is to provide a retaining force against the pressure exerted on the internal walls of the structural member and to maintain the spacing between said walls.

The method advantageously further comprises:

a step of depositing a reinforcing fabric with spaced-apart meshes on the outside faces of the first films;

a step of placing and bonding second films on the first films, through the reinforcing fabrics, to ensure the sealing of the skin, and a step of removing the solid core without destroying the armor wires.

Advantageously, the reinforcing fabrics are connected by stitches to the armor wires prior to the laying of the second films.

According to a first aspect, the material constituting the solid core is a water-soluble foam.

Advantageously, the material constituting the solid core is a starch-based foam.

Alternatively, the method for producing an inflatable structural member according to the disclosed embodiment comprises a step of depositing first films on either side of a system of combs.

The method preferably comprises a step of stitching an armor wire through the assembly formed by the two first films and the combs.

The method advantageously comprises a step of depositing a reinforcing fabric with spaced-apart meshes on the outside faces of the first films.

In order to improve the strength of the member, the method advantageously comprises a step of placing and bonding second films on the first films, through the reinforcing fabrics, to ensure the sealing of the skin.

A step of removing the comb without destroying the armor wires, by withdrawing the combs, in particular towards one another and then parallel to the films, is then provided.

The reinforcing fabrics are advantageously connected by stitches to the armor wires prior to the laying of the second films.

The method may comprise, after stitching, a step of separating the films from one another by means of the comb system.

Alternatively, the method may comprise, prior to stitching, a step of separating the films from one another by means of the comb system.

### BRIEF DESCRIPTION OF THE DRAWINGS

Further features and advantages of the disclosed embodiment will become apparent on reading the following description of a non-limiting exemplary aspect of the disclosed embodiment with reference to the drawings, which show:

FIG. 1 shows a schematic perspective view of an inflatable structural member according to the disclosed embodiment;

FIG. 2 shows an exploded side view of an inflatable structural member according to the disclosed embodiment;

FIG. 3 shows the structural member of FIG. 2 assembled;

FIG. 4 shows the structural member of FIG. 2 in exploded perspective;

FIGS. 5A to 5C show schematic cross-sectional side views of methods for finishing the ends of a structural member according to the disclosed embodiment;

FIG. 6 shows a schematic view of a comb system according to an aspect of the disclosed embodiment;

FIG. 7 shows a schematic perspective view of the laying of films on the system of FIG. 6;

FIG. 8 shows an end-on view of a step of stitching armor wires using the comb system of FIG. 6.

### DETAILED DESCRIPTION

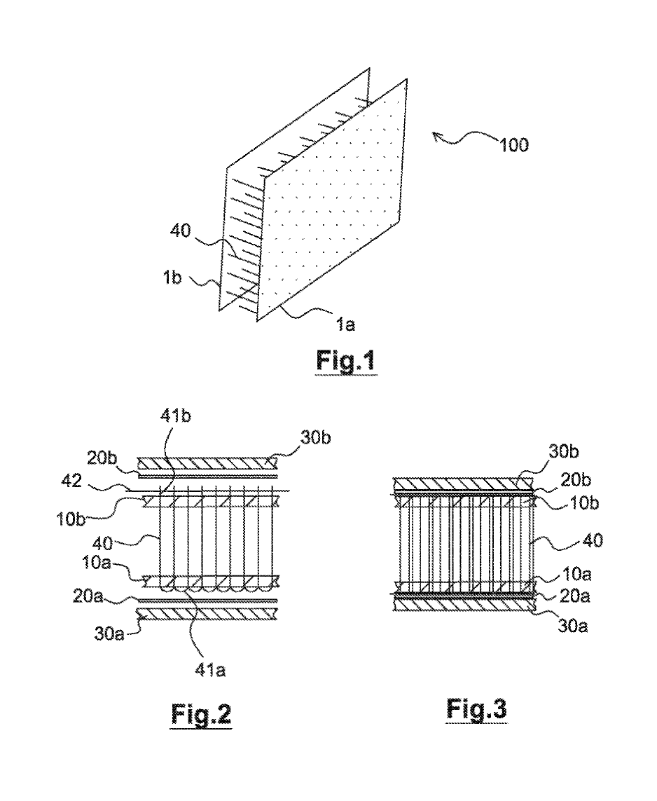

FIG. 1 is a perspective view of a structural member according to the disclosed embodiment in the form of a flexible beam which comprises two sealed skins 1a, 1b connected by armor wires 40 which give the beam its rigidity.

The role of the armor films 40 is to allow the structure to withstand internal pressure, by maintaining a constant distance locally.

According to this example, the skins are parallel and held at a distance by the armor wires when the inside of the beam is pressurized, but it is possible, by varying the length of the armor wires depending on their position on the surface of the skins, to produce beams provided with bulges or constrictions, or to produce beams of variable section or of curved shape.

FIG. 2 shows the various constituent elements of the structural member. Said member comprises the two skins 1a, 1b of FIG. 1 spaced apart to form the external walls of the member. Each skin comprises a first polymer film 10a, 10b. The first polymer films 10a, 10b are located on the inside of the walls of the structural member.

The skins further comprise a reinforcing fabric 20a, 20b which is arranged on the first polymer film.

To finish the skins, a second polymer film 30a, 30b is bonded to the reinforcing fabric and forms the outer surface on both sides of the beam.

This structure provides a sandwich wall structure with an inner film and an outer film encasing a reinforcing fabric.

The reinforcing fabric is made of synthetic fibers such as technical fibers, for example carbon fibers, aramid fibers, polymer fibers or the like.

In particular, it is a fabric with a two-dimensional (2D) structure.

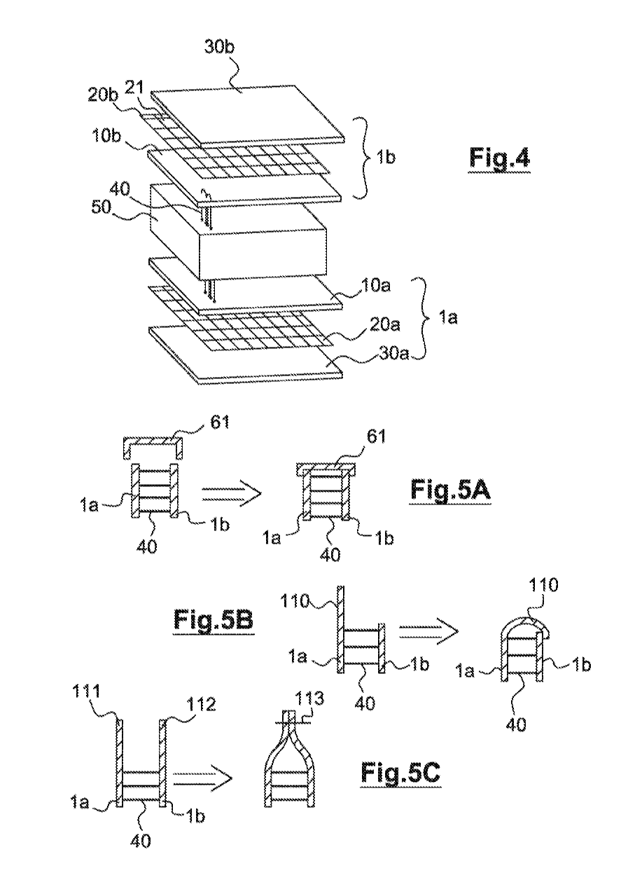

It is made in such a way as to include meshes sufficiently spaced apart to leave holes between meshes which allow bonding between the inner film and the outer film, the meshes 21 seen in FIG. 4 have dimensions adapted as a function of the thickness of the reinforcing fabric, the flexibility of the polymer films and the fluidity of the adhesive to allow bonding between the first and second films.

Thus, according to the disclosed embodiment, a film is bonded on the inside face of the wall of the beam and a film is bonded on the outside face of the beam, trapping the reinforcing fabric between the two films.

This structure has the purpose of improving the sealing of the flexible beams and thus the mechanical performance and the service life thereof.

The advantages of this solution are in particular that the internal pressure exerted on the wall formed by the skin 1 is uniformly distributed over the inner film and therefore over the reinforcing fabric. In addition, the film/film bonding is a perfectly controlled process and the likelihood of separation of the outer film is limited due to the bonding with the inner film. Moreover, this method makes it possible to control the thickness of the reinforced membrane.

According to FIGS. 2 and 3, the films on the inside faces of the skins are connected to each other by armor wires 40 by means of a stitching operation.

One solution to facilitate this stitching process is to place a removable solid core between the two films in order to define the separation between the latter.

Said operation is performed as follows:

a) a porous solid core is cut to the dimensions of the beam;

b) a polymer film is placed on each of the two faces of the core, as shown in FIG. 4;

c) the armor wire is stitched through the assembly and a retaining wire is added to hold the top loop in place, as shown in FIG. 2;

d) a fabric made of synthetic fibers with spaced-apart meshes 20a, 20b is laid on the upper and lower films. Depending on the uses envisaged, the fabric may optionally be connected by stitches to the previous stitching;

e) a second film 30a, 30b is placed, to ensure sealing, on the fabric on the upper and lower faces and said film is bonded to the film of the inside face as shown in FIG. 3, bonding of the inner and outer films, separated by the fabric, being possible due to the presence of holes in the fabric due to the spacing of the meshes 21;

f) the solid core is removed without destroying the armor wires.

A compromise between the surface area of bonding, the surface area of the holes and the mechanical properties of the fabric may be defined depending on the sector of use of the beam.

The methods used for bonding will be the same as those currently used for bonding films together, either by means of adhesive or by heating/welding.

An exemplary aspect of the material used for the solid core is a starch-based water-soluble foam. Such a foam is sufficiently strong to ensure that the sandwich material does not collapse under the pressure of stitching and the pressure of bonding the external film, but also sufficiently soft to allow the needles to pass through.

Other methods for making the skin may be envisaged, and in particular an alternative to the solution of the removable solid core is the following: after stitching, connecting the two faces at a distance equal to the thickness of the beam, the two inner films are separated by a system of combs 201, 202, and then step e) of the operation is performed.

Several solutions are possible to close the beam:

a) Bonding of a cover 61 to each edge, shown in FIG. 5A;

b) Bonding of a skin 1a which forms a flap on the other skin 1b, shown in FIG. 5B;

c) Bonding of the ends 111, 112 of the skins 1a, 1b to one another, as in FIG. 5C, possibly with stitching 113 at the ends before bonding the films.

The end-to-end assembly of several beams of this type makes it possible to produce a support or skeleton structure, for example in order to support elements of deployable structures of satellites.

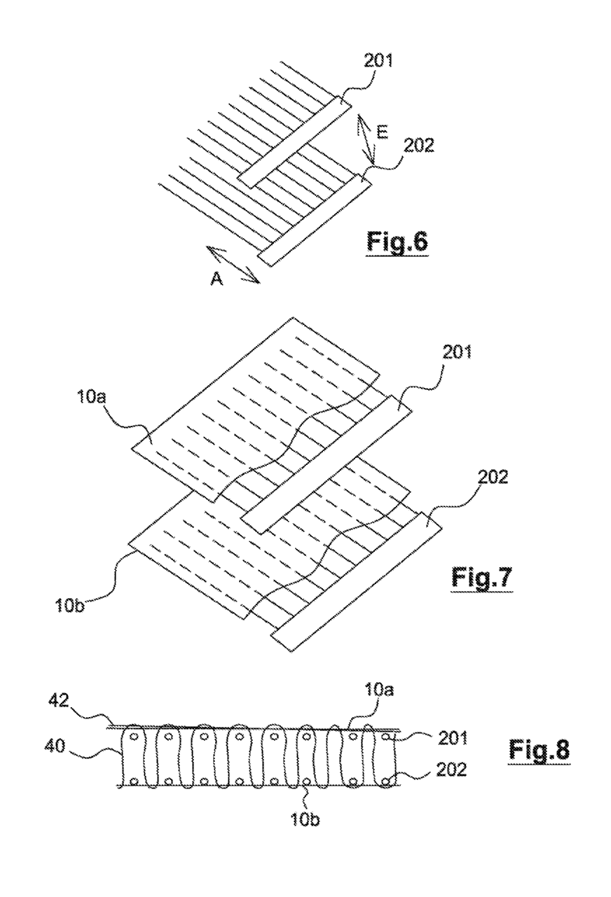

An example of a comb system is shown schematically in FIG. 6, said system in this case comprising two combs 201, 202 which are movable with respect to each other with a gap E, and which can move together or separately in their plane along the direction A of the teeth of the combs.

The method in this case comprises a step of depositing first films 10a, 10b on either side of the comb system as shown in FIG. 7, with the combs apart.

A step of stitching an armor wire 40 is then performed through the assembly formed by the two first films 10a, 10b and the combs 201, 202. The stitching step optionally comprises the addition of a retaining wire 42 to hold the loops in place on one side of the stitching, as shown in FIG. 8.

The comb system is designed so that the teeth or rods of the comb correspond to the stitch spacing or a multiple or submultiple of the stitch spacing.

Either the comb system comprises two combs kept spaced apart at the distance corresponding to the inflated beam, as shown, and the stitching is performed with the first films resting on the combs with the armor wires taut, or the stitching is performed with loose loops, the two combs being first brought together. In this case, a step of separating the films from one another is carried out by separating the combs of the comb system, thereby stretching the armor wires.

As in the method with the solid core, a step of depositing a reinforcing fabric with spaced-apart meshes on the outside faces of the first films is carried out with the combs apart.

In order to ensure the sealing of the skin, the same procedure as in the case of the solid core is used for placing and bonding second films on the first films, through the reinforcing fabrics.

Lastly, a step of removing the comb system without destroying the armor wires is performed, for example by bringing the two combs together and then withdrawing them in a direction parallel to the surface of the films.

The reinforcing fabrics are advantageously connected by stitches to the armor wires prior to the laying of the second films.

An inflatable wing, consisting of an assembly of beams according to the disclosed embodiment, inflated, equipped with surface actuators, for modifying the aerodynamic properties of the wing, would make it possible to substantially lighten the structure of a drone.

The disclosed embodiment defined by the claims is not limited to the examples shown, and in particular the length of the armor wires and the spacing thereof may vary depending on where they are located between the skins.

What is claimed is:

1. A multilayer sealed skin, in particular for an inflatable structure, comprising a first polymer film, a reinforcing fabric arranged on the first polymer film, and a second polymer film arranged on the reinforcing fabric and bonded by means of an adhesive to the first polymer film through holes in the reinforcing fabric.

2. The multilayer sealed skin as claimed in claim 1, wherein the reinforcing fabric comprises meshes, the dimensions of which are adapted as a function of the thickness of the reinforcing fabric, the flexibility of said polymer films and the fluidity of the adhesive to allow bonding between the first and second films.

3. The multilayer sealed skin as claimed in claim 1, wherein the reinforcing fabric is a synthetic fiber fabric.

4. An inflatable structural member such as an inflatable beam comprising two sealed skins as claimed in claim 1, spaced apart so as to form the outer walls of the structural member, wherein the first film of each of the skins forms an inside face of the outer wall of the structural member and the second film of each of the skins forms an outside face of said wall.

5. The inflatable structural member as claimed in claim 4, wherein the two sealed skins are connected to one another by armor wires which give the structural member rigidity.

6. The inflatable structural member as claimed in claim 5, wherein the armor wires connect the first films of the two skins by means of a stitching operation, the reinforcing fabrics of the skins covering the loops of the wires on the outside face of the first films.

7. The inflatable structural member as claimed in claim 6, wherein the second films of the skins are bonded to the first films through the holes between the meshes of the reinforcing fabrics, the loops of the stitching being embedded in the adhesive between the first and second films.

8. A method for producing an inflatable structural member as claimed in claim 4, comprising a step of depositing first films on either side of a removable solid core between the two films, a step of depositing reinforcing fabrics with spaced-apart meshes on the outside faces of the first films;
a step of placing and bonding second films on the first films, through the reinforcing fabrics, to ensure the sealing of the skin; and
a step of removing the solid core.

9. The method for producing an inflatable structural member, wherein the two sealed skins are connected to one another by armor wires which give the structural member rigidity, as claimed in claim 8, comprising a step of stitching an armor wire through the assembly formed by the two first films and the solid core, between the step of depositing the first films and the step of depositing the reinforcing fabrics, the step of removing the solid core being performed without destroying the armor wires.

10. The method for producing an inflatable structural member as claimed in claim 9, wherein the reinforcing fabrics are connected by stitches to the armor wires prior to the laying of the second films.

11. The method for producing an inflatable structural member as claimed in claim 8, wherein the material constituting the solid core is a water-soluble foam.

12. The method for producing an inflatable structural member as claimed in claim 11, wherein the material constituting the solid core is a starch-based foam.

13. A method for producing an inflatable structural member as claimed in claim 4, comprising a step of depositing first films on either side of a system of combs, a step of depositing a reinforcing fabric with spaced-apart meshes on the outside faces of the first films; a step of placing and bonding second films on the first films, through the reinforcing fabrics, to ensure the sealing of the skin; a step of removing the comb system, by withdrawing the combs towards one another and then parallel to the films.

14. The method for producing an inflatable structural member, wherein the two sealed skins are connected to one another by armor wires which give the structural member rigidity, as claimed in claim 13, comprising a step of stitching an armor wire through the assembly formed by the two first films and the combs; the step of removing the comb system being performed without destroying the armor wires.

15. The method for producing an inflatable structural member as claimed in claim 14, wherein the reinforcing fabrics are connected by stitches to the armor wires prior to the laying of the second films.

16. The method for producing an inflatable structural member as claimed in claim 13, comprising, after stitching, a step of separating the films from one another by means of the comb system.

17. The method for producing an inflatable structural member as claimed in claim 13, comprising, prior to stitching, a step of separating the films from one another by means of the comb system.
